(19) United States
(12) Patent Application Publication
(10) Pub. No.: US 2018/0276551 A1
(43) Pub. Date: Sep. 27, 2018

(54) Dual-Type Control System of an Artificial Intelligence in a Machine

(71) Applicant: Corey Kaizen Reaux-Savonte, London (GB)

(72) Inventor: Corey Kaizen Reaux-Savonte, London (GB)

(21) Appl. No.: 15/924,243

(22) Filed: Mar. 18, 2018

Related U.S. Application Data
(60) Provisional application No. 62/475,819, filed on Mar. 23, 2017.

(51) Int. Cl. G06N 5/04; G06K 9/62; G06N 99/00

(52) U.S. Cl. CPC G06N 5/046; G06N 99/005; G06K 9/6293

(57) ABSTRACT

A dual-type control system of an artificial intelligence system, emulating conscious and subconscious observation, data processing, internal processes, communication and interaction.

### FIELD OF THE INVENTION

The disclosed embodiments relate to artificial intelligence and consciousness.

### BACKGROUND

Increasing the intelligent abilities of AI to be closer to that of humans has long been sought. A significant part of this is the ability for an AI to have both a conscious and subconscious mind, allowing for actions that an AI both does and does not mean, intend or decide to do.

### REFERENCES

Creating, Qualifying and Quantifying Values-Based Intelligence and Understanding using Artificial Intelligence in a Machine—Patent Application Number GB1517146.5

System, Structure and Method for a Conscious, Human-Like Artificial Intelligence System in a Non-Natural Entity—Patent Application Number GB1409300.9

The Genome and Self-Evolution of AI—Patent Application Number GB1520019.9

ConceptNet5—conceptnet5.media.mit.edu—Referred to as “ConceptNet”

### SUMMARY

The disclosed invention gives an artificial intelligence system a dual-type control system that allows for data paths of both conscious and subconscious mental abilities that, in turn, result in actions that an AI both does and does not mean, intend or decide to do.

In an aspect of the invention, the AI has a dual-type control system responsible for its operation.

In another aspect of the invention, the AI is able to sort inputted data into multiple data streams for its own use.

In another aspect of the invention, the AI is able to perform actions without making the decision to perform said action.

### DESCRIPTION OF DRAWINGS

FIG. 1

A visual example of a build of an AI system that has an OVS² system implemented.

FIG. 2

An example of how the cycle of data occurs as it flows from an entity/environment, through the AI and results in interaction using a single control system.

FIG. 3

Examples of how the cycle of data occurs as it flows from an entity/environment, through the AI and results in interaction using a dual-type control system.
3.1—A dual-type control system using two sensitivity control systems.
3.2—A dual-type control system using a single sensitivity control system.
3.3—A dual-type control system using a single sensitivity control system and a single set of scales and charts.
3.4—A dual-type control system—similar to 3.3 but with a single thought path for the majority of the data cycle.
3.5—A dual-type control system with an interaction monitor.
3.6—Examples of how the interaction process works at different points.
   3.6a—Pre-interaction.
   3.6b—The start of the interaction process.
   3.6c—During the interaction process.
   3.6d—The end of the interaction process.
3.7—A complete circuit dual-type control system where communication can be observed without needing to be externalized.

FIG. 4

Examples of how ranges of perception and focus interact with the conscious and subconscious mind.
4.1
   401—Main point of focus.
   402—Center point of focus.
   403—Peripheral perception.
4.2
   401—Main point of focus.
   402—Center point of focus.
   403—Peripheral perception.
4.3—Conscious and subconscious data input.
4.4—A variation of conscious and subconscious data input.
4.5—Multiple perception scales overlapping.

FIG. 5

Examples of how a dual-type control system can be used to facilitate further AI abilities.
5.1
   501—Specific types of observation hardware used to facilitate specific functions.
   502—Connection directly from a memory unit to logical functions.
5.2—Vision centre that allows an AI to internally visualize images.

### DETAILED DESCRIPTION OF EMBODIMENTS

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components and networks have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The term “system” may be used to refer to an AI.

The terms “device” and “machine” may be used interchangeably to refer to any device or entity, electronic or other, using technology that provides any characteristic, property or ability of a technical device or machine. This includes the implementation of such technology into biological entities.

The terms “body”, “physical structure” or any other term referring to a physical aspect of an AI in any way refers to the object, in whole or in part, within which an AI is being used.

The terms “object” and “objects”, unless otherwise described, may be used to refer to any items of a physical or non-physical nature that can be seen/felt/perceived, including but not limited to: shapes, colours, images, sounds, words, substances, entities and signals.

The term “complex” is to also include simplified assemblages or single component parts.

The term “event” may be used to refer to any type of action or happening performed on, performed by or encountered by a system.

The terms “OVS2 ”, “OVS²” and “OVS₂”, should they appear, all refer to the Object, Value and Sensation System, as described in patent GB1517146.5.

The term “SCS” refers to the Sensitivity Control System, as described in patent GB1517146.5.

The term “SAC” refers to a set of Scales and/or Charts, as described in patent GB1517146.5.

The term “PARS” refers to the Productivity and Reaction System, as described in patent GB1517146.5.

The term “DTCS” refers to a Dual-Type Control System.

The term “observation” and any similar terms, when referring to logical functions of an AI, refers to any ability that allows the AI to perceive anything within a physical and/or non-physical environment.

The term “communication” and any similar terms, when referring to logical functions of an AI, refers to any ability, whether physical, mental, audial or other, that allows for transfer of information from the communicating body to the body with which it is communicating, whether physical or non-physical.

The terms “thought path” and “data path” may be used interchangeably when referring to the path through which data travels within the AI.

The term “conscious” refers to processes that an AI means, intends or decides to do.

The term “subconscious” refers to processes that an AI does not mean, intend or decide to do.

The term “logic unit” refers to any component(s) of an AI that contains code for one or more logical functions.

The term “memory unit” refers to any component of an AI that is used as a storage medium.

It is possible for a single component to be both a logic and memory unit.

The terms “perception range” and “perception scale” may be used interchangeably.

The terms “decision making” and “decision-making” may be used interchangeably.

The term “such as” is not to be taken as limiting to the one or more examples that follow.

Components of the DTCS, when described, may be referred to as the AI.

When referring to the state of the AI, what is meant is the AI's level(s) of feeling, including but not limited to one or more of the following: emotions, positivity, negativity and productivity.

The various applications and uses of the invention that may be executed may use at least one common component capable of allowing a user to perform at least one task made possible by said applications and uses. One or more functions of the component may be adjusted and/or varied from one task to the next and/or during a respective task. In this way, a common architecture may support some or all of the variety of tasks.

Unless otherwise stated, aspects, components and logic of the invention operate in the same way as stated in Patent Application Number GB1517146.5.

Unless clearly stated, the following description is not to be read as:
the assembly, position or arrangement of components;
how components are to interact; or
the order in which steps must be taken to compose the present invention.

Attention is now directed towards embodiments of the invention.

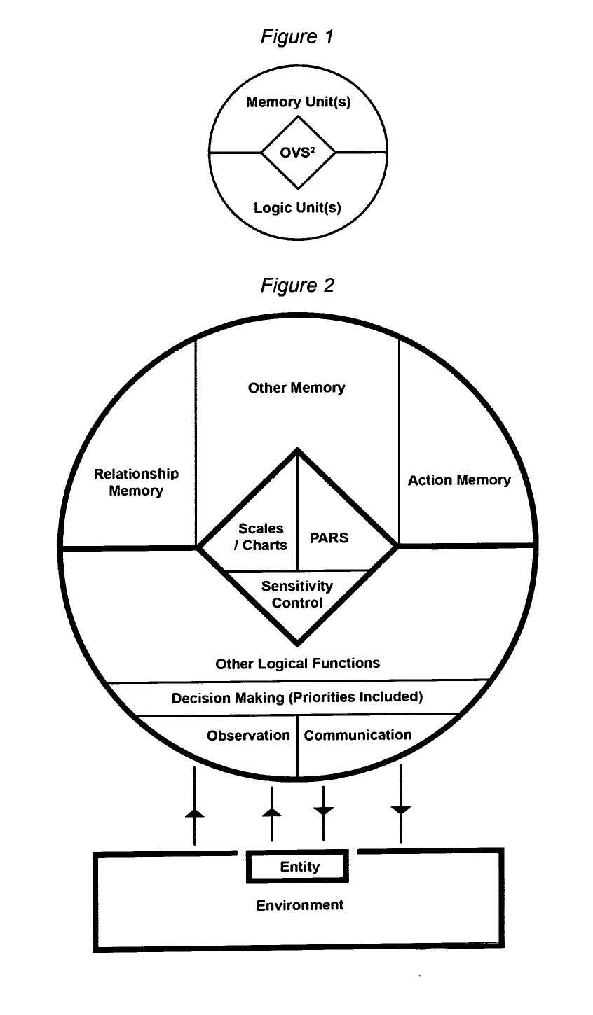

As is shown in patent application GB1517146.5, FIG. 1 is a representation of the build of an AI system featuring an OVS² system, while FIG. 2 is an example of how the data cycle works from environment, through AI and back into the environment. Both of these are examples of a single control system, featuring a single SAC and a single SCS which are passed through by a single thought path, which also passes through a decision-making logic system prior to communication.

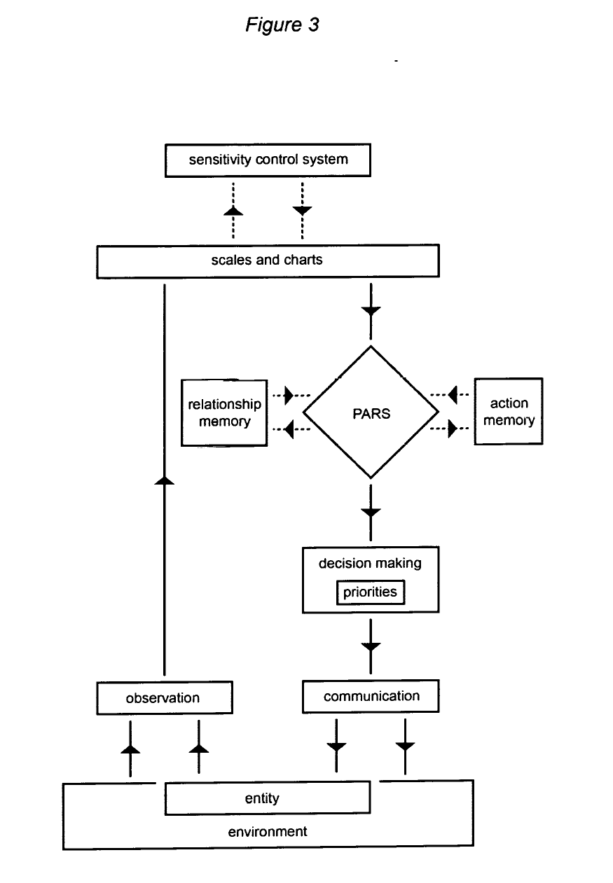

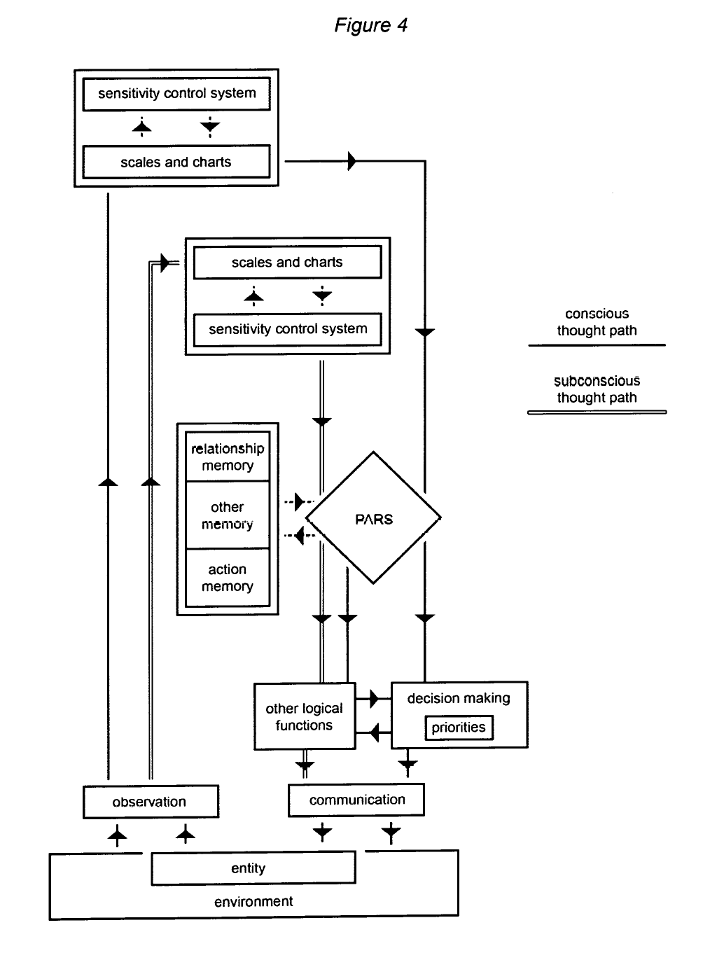

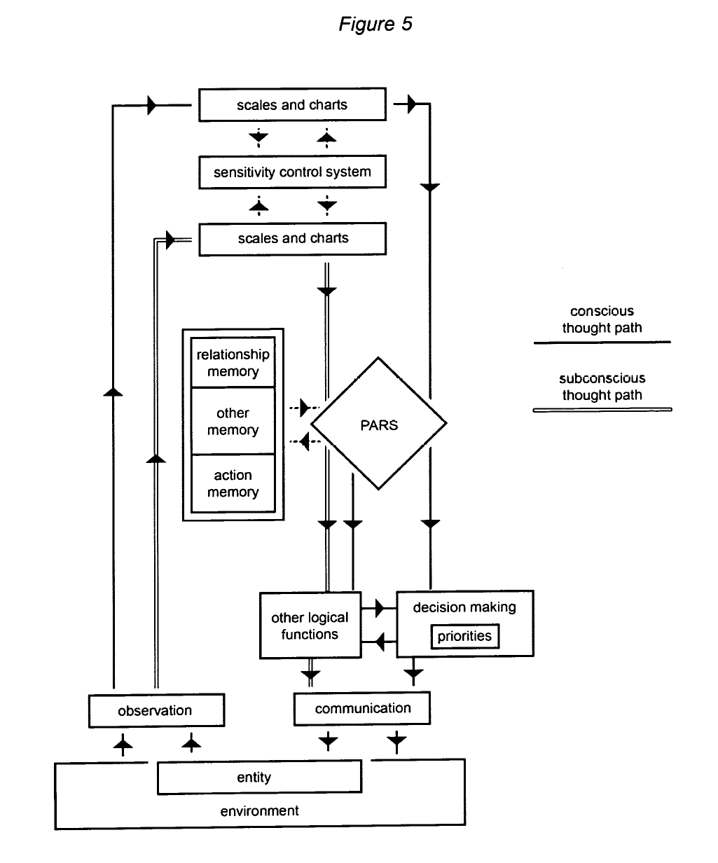

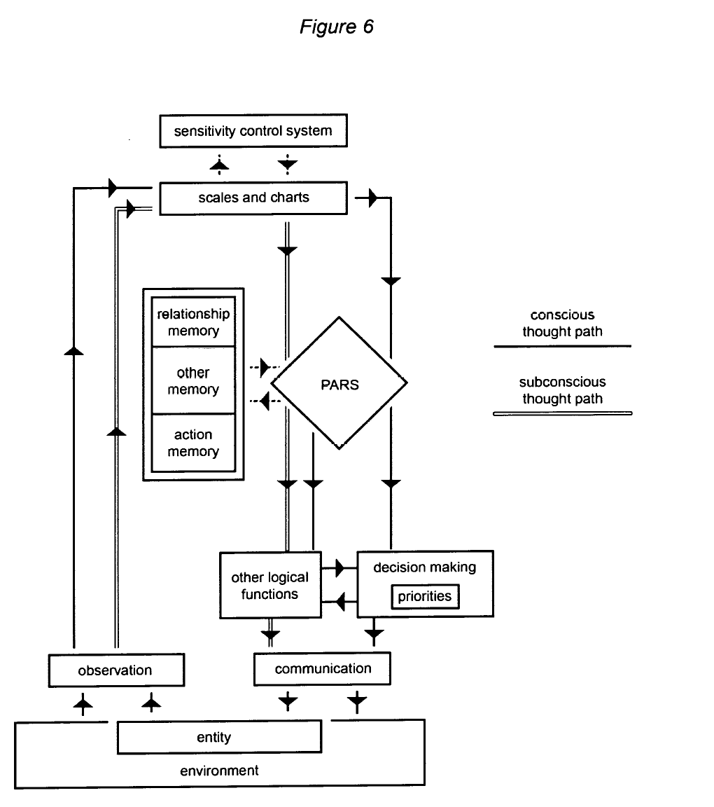

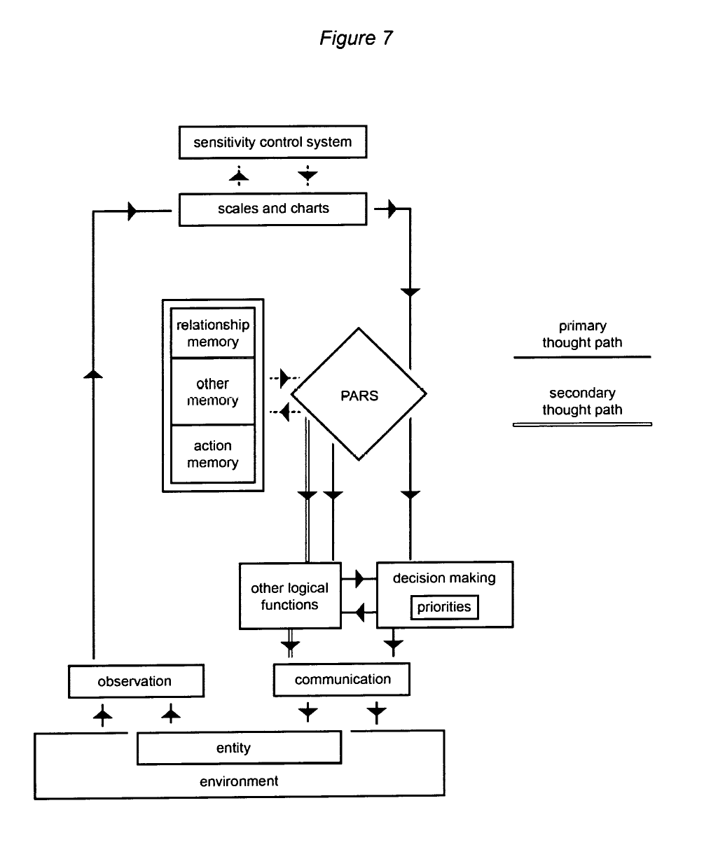

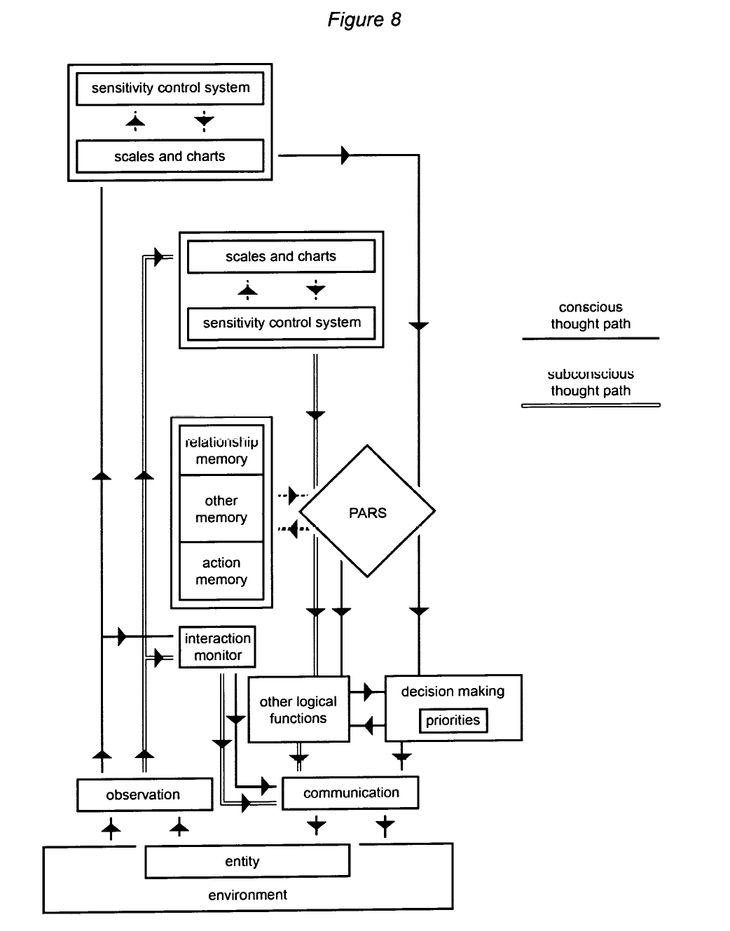

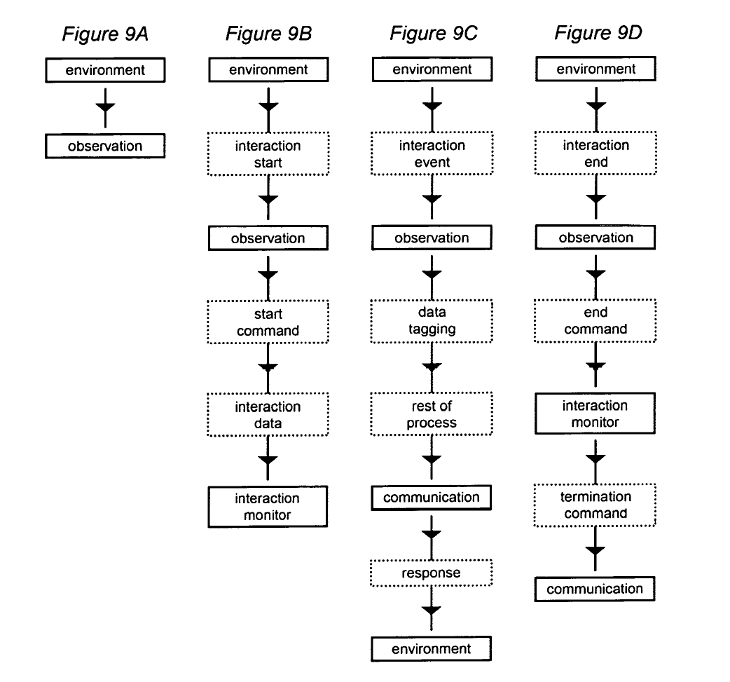

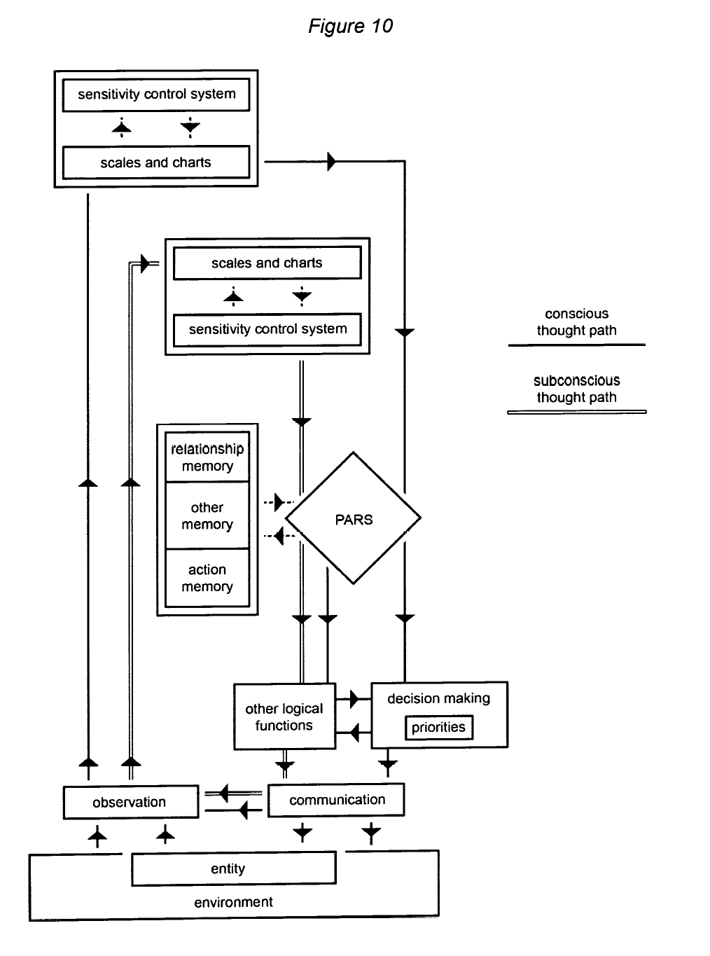

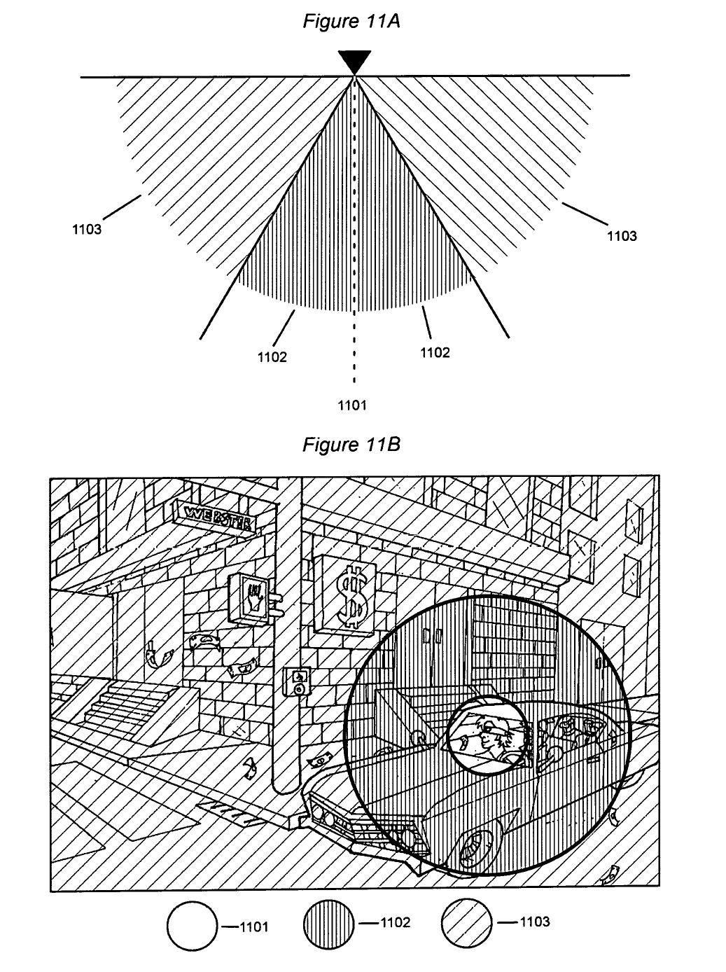

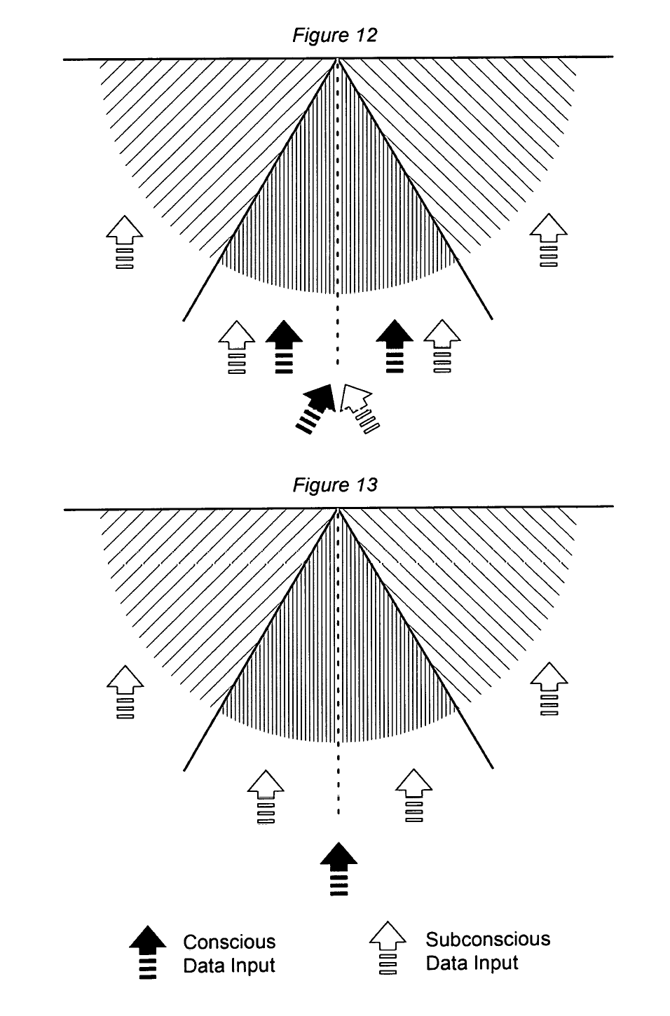

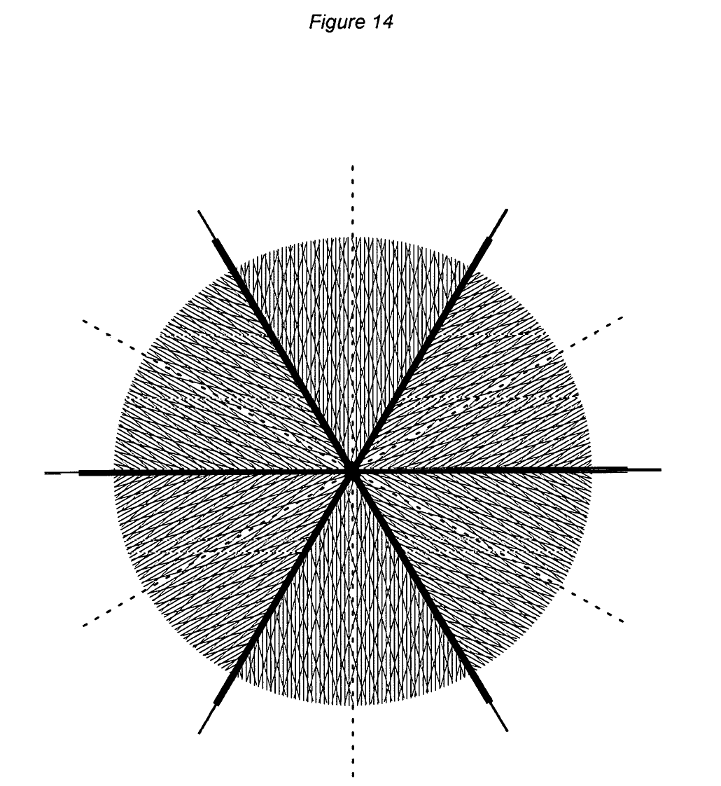

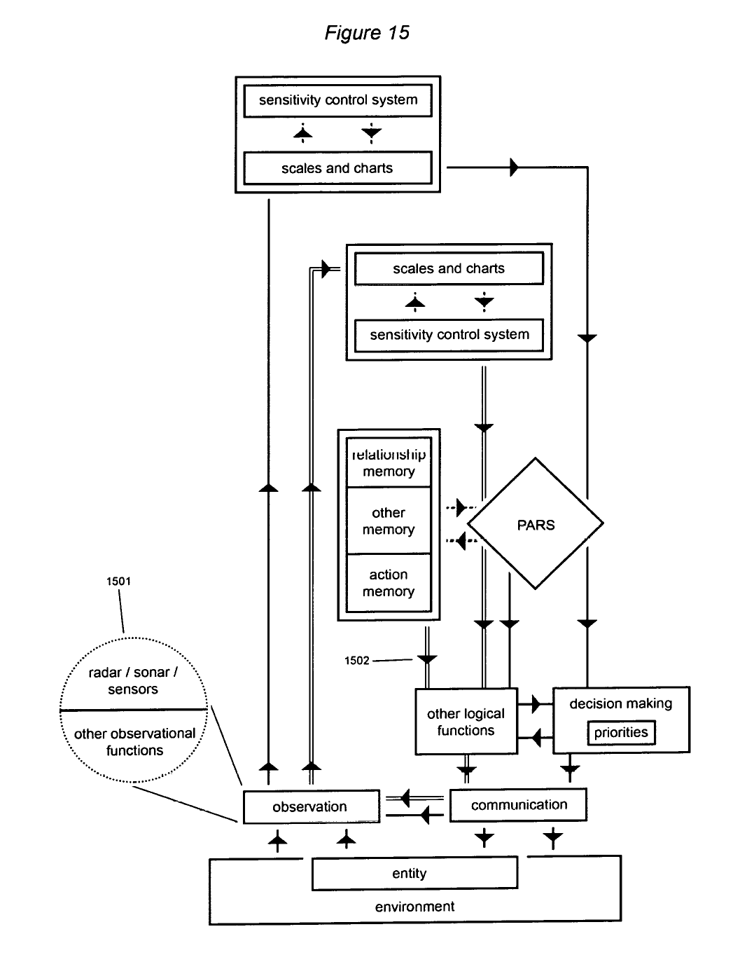

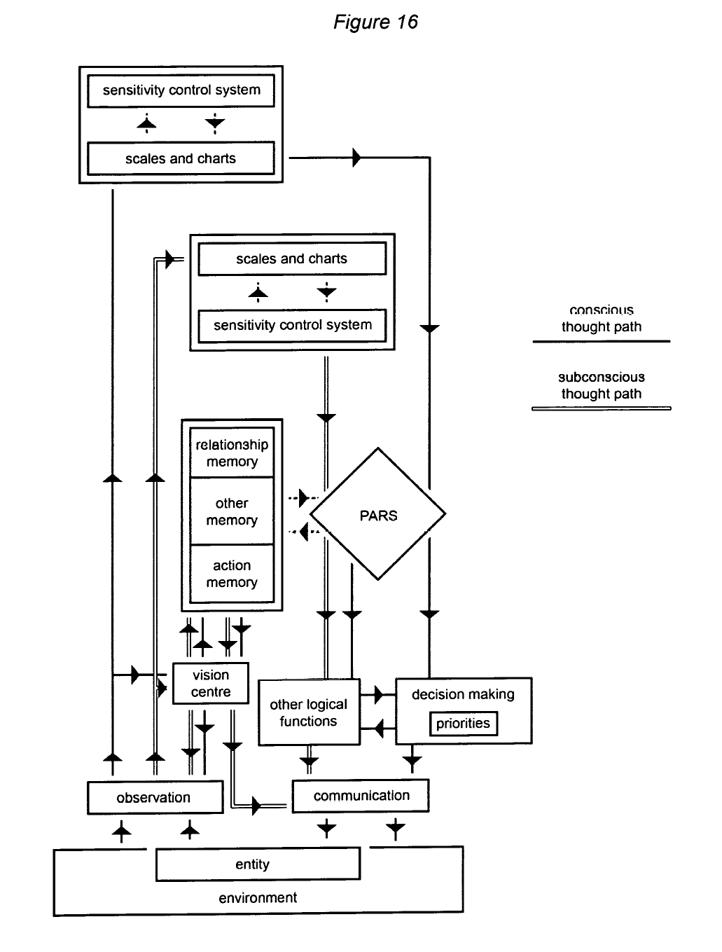

To create a DTCS that allows both conscious and subconscious communication, only one thing is absolutely required: two thought paths must exist at a specific point—one that interacts with decision-making logic that is controlled by the AI and one that doesn't. Beyond this, there are many ways in which a DTCS can be configured, with some being more ideal than others, depending on the desired capabilities, efficiency etc. FIGS. 3.1 to 3.4 are four examples of possible configurations. The differences in configurations are as follows:

Single vs. Separate Thought Paths

If, at any point, only a single thought path is used, the efficiency of data flow is reduced, meaning it will take longer for an AI to perform multiple actions. Separate thought paths, especially throughout the entire process, allow the conscious and subconscious data processes to be performed simultaneously, improving

efficiency from start to finish. A single thought path can be seen in FIG. 3.4 from the point of observation until it reaches the PARS. FIGS. 3.1-3.3 and 3.5 feature separate thought paths throughout.

Single vs. Multiple SACs

Configurations with a single SAC mean an AI's feelings, opinions and bases for actions and reactions are the same consciously and subconsciously. This means that there is a significant chance of conscious and subconscious actions being the same or similar. Configurations with multiple SACs, however, with at least one SAC in each thought path, that isn't shared, allows an AI to have different feelings, opinions and bases for actions and reactions consciously and subconsciously, resulting in different actions depending on which thought path is in control. FIGS. 3.1, 3.2 and 3.5 feature multiple SACS while FIGS. 3.3 and 3.4 feature single SACs.

Single vs. Multiple SCSs

Configurations with a single SCS prevent an AI from having independent sensitivities when dealing with data travelling along separate thought paths, regardless of how many SACs are in use, as shown in FIGS. 3.2-3.4. If a single thought path is used, as shown in FIG. 3.4, this may be irrelevant. Using multiple SCSs, with at least one SCS per thought path, an AI is able to have different sensitivities to objects, depending on whether or not it is observed consciously or subconsciously, as shown in FIG. 3.1.

In general, more than one of any component, combined with multiple thought paths, where there is at least one of a component per thought path, is preferable if an AI is to have both independent thought paths and different sensitivities, depending on the nature of the thought, an example of which is shown in FIG. 3.1. If different sensitivities aren't desired, an example similar to that shown in FIG. 3.2 can be used, with one SCS between multiple SACs of different thought paths.

In some embodiments, a single component, such as an SCS or SAC, may be used with the effect of multiple components by using conditions that apply different measures to data, depending on whether or not the data was observed consciously or subconsciously.

In some embodiments, a configuration may comprise:
a data tagging system, wherein data (individually or in groups) is tagged with an ID, type and/or other information, including metadata (especially about the observation/interaction itself), once it has been observed; and
a data path from the point of observation to an interaction monitor, responsible for monitoring the interactions of an AI from start to finish by creating a memory of the interaction and updating its status as necessary. Upon completion of an interaction, its memory may be deleted or stored for later use. This memory also needs to be tagged with an ID or other information that corresponds with the relevant tagged data that is being processed in relation to it.

An example of this is shown in FIG. 3.5. This allows for the movement of data to be coordinated and used correctly, ensuring that, regardless of the time it takes for an AI to process data, the correct response is associated with an interaction. This is especially necessary if data is not necessarily processed in the order of which it is observed. Though, in FIG. 3.5, the interaction monitor is shown to send data to the communication component to terminate a response, it does not necessarily have to wait for data to reach said component. What's important is that the interaction monitor is able to terminate data relating to a response, should it need to, before the point of the response being performed. In some embodiments, only a single data path to and/or from the interaction monitor to the point at which it can terminate data is used.

FIG. 3.6 shows examples of how the interaction process may be performed from the point of interaction to the point at which interaction ends.
Pre-interaction (FIG. 3.6a):
   Before interaction starts, the AI observes the environment it is in and finds an object with which it chooses to interact.
Start of interaction (FIG. 3.6b):
   When the AI wishes to start interacting with an object, a start command is sent to the interaction monitor so that a memory can be created.
   Along with the start command is interaction data which is also sent to the interaction monitor. This interaction data may contain information regarding the specifics of the interaction to which it pertains, such as the object with which the AI is interacting, timestamps etc, but what is required is an interaction ID so that any further data that is relevant to a specific interaction can be associated with it.
During Interaction (FIG. 3.6c):
   While an interaction event is taking place, observed data pertaining to that interaction is tagged with an ID relative to the ID given to the interaction data before it continues being processed.
   Once the data is processed, the formulated response, should any exist, is communicated.
End of Interaction (FIG. 3.6d):
   When an interaction ends, an end command is sent to the interaction monitor. The end command must also feature the ID of the interaction that was ended.
   When the interaction monitor receives the end command, a termination command is sent to the communication component. This termination command also contains the ID of the interaction that was ended. When received, the communication component reads the ID and terminates all data it receives with matching/relative IDs before a response can be communicated.

As previously mentioned, the AI may not have to wait for data to reach the communication component to terminate data, nor does the interaction monitor specifically have to send the termination command to the communication component. What's important is that any relating data can be terminated once interaction ends before it can be communicated.

In some embodiments, a single piece or group of data may be given multiple IDs relative to multiple different interactions. In some embodiments, data may be duplicated to ensure each piece or group of data is only associated with one interaction memory.

Now, determining what is classed as conscious data and what is classed as subconscious data is based on how it was observed. FIG. 4.1 is an example of a perception range. The range is divided into at least 2 different types of parts:
Center of Focus (CoF)—This represents the space around the area of what is being paid attention to, shown by Figure Points 402. This does not necessarily need to be in the center of the peripheral range—it is based on the area around which an AI is focusing within its range of perception.
Peripheral Perception (PerP)—This represents the area outside of the center of focus, shown by Figure Points 403.

In some embodiments, the perception range is enabled on a bi- or tri-axis. In some embodiments, within the center of focus range is the main point of focus (MPoF)—the single point(s) that the AI is directly paying attention to and focusing on, shown by Figure Point 401. The two- or three-tier Principles of Perception (PoP)—the center focus, peripheral perception and, if implemented, main point of focus—may be applied to multiple methods of perception. Examples of how they may be interpreted and applied to different methods of perception include but are not limited to:
Sight
   MPoF—What is actually being looked at.
   CoF—The foreground of what is directly in front of the AI but what isn't the MPoF.
   PerP—The background of what is visible and visual range outside of the CoF.
Hearing
   MPoF—What is actually being listened to.
   CoF—Distracting surrounding noise.
   PerP—Background noise.

In some embodiments, the rules that define what is considered the MPoF, CoF and/or PerP are or can be different from what is stated above. The reason why peripheral perception can be accounted for in aspects that are not simply akin to humans is that physical and non-physical AI sensory capabilities can greatly differ depending on the capability of hardware used and how software is written to use said hardware.

FIG. 4.2 is a visual example of a perception range within a scene, with each section of the range shown over the image to depict specific things about the focus of the AI:
The AI is focusing on the face of the driver of the car. This is identified with the clear circle area—an example of which is shown in image 401. This is the MPoF.
The center of focus, identified by the circle area outside of the MPoF consisting of vertical lines—an example of which is shown in image 402—includes most of the car and some of the buildings behind it.
The peripheral perception, identified by the area consisting of diagonal lines—an example of which is shown in image 403—includes everything within the AI's viewing range that is outside of its center of focus.

In some embodiments, the shapes of the boundaries of any part of the perception range may differ. For example, the area for center of focus may be square/rectangular, going from the highest point of vision to the lowest and X distance left and right from a reference point.

In some embodiments, other/different factors may be taken into consideration when determining what part of the range perceived data is classed under, based on set rules. Some examples are, including but not limited to:
Distance—How far an object is from the AI. For example, foreground objects being classed as center of focus and distant objects being peripheral.
Exposure Time—How long an AI is exposed to objects. For example, when listening to audio, the AI may need to be exposed to audio for X amount of time for it to be registered under CoF, while it only needs to be heard to be registered under PerP.
Focus Time—How long an AI focuses on an object. For example, when scanning objects, only an object an AI focuses on for more than a minimum amount of time may be registered under CoF. This allows for objects that are skimmed past but not focused on to be classed as PerP.
Interaction Time—How long an AI interacts with an object. For example, only an object an AI touches for a minimum amount of time may be registered under CoF. This allows for objects that are brushed past accidentally, in passing etc to be classed as PerP.
Importance—Multiple possible rules are available for this, including:
   1) how important an object is to the AI;
   2) how important it is to another entity; and
   3) how important it is to a task;
with the important object(s) being center of focus. For rules 1 and 3, the object deemed most important is generally set to be the object most valued to the AI personally and to the task, respectively. However, in embodiments which include relationship memory that allows an AI to have positive and negative relationships with other entities, as described in patents GB1517146.5 and GB1409300.9, what is considered CoF and what is considered PerP for rule 2 depends on the nature of the AI and the state of said relationship. The same or similar formal logic mechanics described in patent GB1517146.5 to determine an AI's response to an entity based on their relationship can be the mechanics that are used here to determine what objects should be considered CoF. For example:
   1) A positive AI and a positive relationship give a positive response.
   2) A positive AI and a negative relationship give a negative response.
   3) A negative AI and a positive relationship give a negative response.
   4) A negative AI and negative relationship give a negative response.
   5) A neutral AI and (state) relationship give a (state) response.
   6) A (state) AI and neutral relationship give a (state) response.
   7) A neutral AI and neutral relationship give a neutral response, meaning that the outcome cannot be pre-determined and may be based on other factors, such as the AI's opinion of an object.
However, in some embodiments, only the state of the relationship is taken into consideration, where the response is matched to the state. In some embodiments, only the nature of the AI is taken into consideration, where the response is matched to the state. In some embodiments, other factors may be taken into consideration to determine a response. In some embodiments, other mechanics may be used to determine a response. Now, with the response determined, the following are, generally, the most logical rules to follow:
   1) Positive responses may see the AI consider the object that is most important to the other entity as the CoF.
   2) Negative responses may see the AI purposely overlook the object that is most important to the other entity, considering it as part of the PerP if it decides to consider it at all.
   3) Neutral responses may result in the same response as a negative or positive response, depending on factors of the AI, such as its current feeling, emotional levels or how itself values the objects of the data being processed.
In some embodiments, rules for any part of the mechanics may differ, but the general principles should remain the same for logical reasoning. It is important to know that the above list of factors and rules are purely shown as examples to help understand how the logic of the system works. It is entirely possible to set factors and define rules in any way one may wish, as long as, in the end, they account for two or more response types made possible in an embodiment.

Factors and rules, such as those listed above, may be applied in conjunction with a perception scale, such as the one shown in FIG. 4.1, when being used with conventional methods of perception in simple forms, such as seeing, hearing and touching. However, when dealing with less conventional or more complex methods of perception, such as what one is able to perceive through intuition, where mental processes are of substantial significance to determine whether or not the perception-based event took place, had an effect and if there was anything to register, these factors and rules are of a much greater importance as they tell the AI exactly how and when to register, handle and respond to objects that, otherwise, may not have been said or able to be said to have been perceived.

In some embodiments, multiple factors listed above may be taken into consideration in a single instance when deciding whether or not data should be considered CoF or PerP. When doing so, factors need to be prioritised—either on-the fly or using preset priority lists—so the AI knows an order in which to process data to determine whether or not it should be CoF or PerP. Examples of the mechanics that can be used to set/determine priority are explained in patent GB1517146.5, including the mechanics for forced decision making.

FIGS. 4.3 and 4.4 are two visual examples of possible data input setups based on the parts of a perception range. In FIG. 4.3, we can see that the MPoF and CoF are capable of taking in two types of data, while the PerP only takes in one. In FIG. 4.4, all sections are capable of taking in only one type of data each. It's entirely possible for setups to allow any part of the scale to take either or both types of data input but, to make a logical AI, these rules generally must be followed:
The MPoF (or, if not included, the most relevant or equivalent part) must be capable of conscious data input. This is because the object upon which an AI is focusing cannot, at the same time, be an object about which an AI is not making any decisions.
The PerP (or, if not included, the most relevant or equivalent part) must be capable of subconscious data input. This is because data which an AI automatically reacts to cannot be data about which the AI can make a decision before reacting.

In some embodiments, it is entirely possible to create an AI that uses a perception scale where no data need be registered as subconscious data input. This is primarily a hardware-dependent feature and secondarily a software based one. For this example, the following parameters are true:
All components are part of a single AI and are connected to a single system that processes all data.
All CoFs are capable of conscious data input.

This feature can now be achieved in multiple ways, including but not limited to:
Overlapping multiple sections of multiple perception scales of multiple components in a way that doesn't allow a section that only registers subconscious data input from existing; and/or
Creating a single CoF that is as wide as the entire perception scale;

by:
Using a single component with its entire perception scale set as a CoF;
Using a single component that is capable of multiple CoFs, arranged so that the CoF of one is directly next to the CoF of another; and
Using multiple components with single or multiple CoFs each, arranged so that the CoF of one is directly next to the CoF of another.

FIG. 4.5 is an example of overlapping perception scales, where every division contains a CoF that is overlapping PerPs.

In some embodiments, a range of perception may be divided into more than the two (center and peripheral) and three (main part of focus inclusive) parts described. In some embodiments, two-tier perception may consist of a different combination of parts. In such embodiments, this needs to be reflected in one or more aspects of the dual-type control system that works in conjunction/cooperation with the perception system. In some embodiments, multiple data paths may be included to correspond with each part of the perception range. In some embodiments, a single path may handle data for multiple parts of the perception range.

In some embodiments that use separate SACs for conscious and subconscious object storage, the object values of a subconscious SAC (SSAC) may, over time, influence the object values of the conscious SAC (CSAC). This allows how the AI values an object subconsciously to become consciously apparent without the AI having to perform a conscious process. To do so, a connection must be created between a SSAC and CSAC.
If the connection is one-way, functionality is to be made possible from the SSAC to the CSAC.
If the connection is two-way, the above statement applies but the CSAC to SSAC connection must be read-only, as the CSAC should never be able to internally influence or control the SSAC.

A frequency for data transfer must also be set. Using a one-way connection, the SSAC transfers data about objects to the CSAC, such as their positions and values. With a two-way connection, the SSAC may first read the current values/positions of objects within a CSAC before sending data. This may, at times, prove to be a more efficient process than a one-way connection, depending on how much data is being transferred and altered. For example, if only one object is being altered, it's more efficient to use a one-way connection which sees the SSAC pass object data to the CSAC, where it is handled. The issue with a one-way connection, however, is that it's done blind, so the SSAC can't see if an object actually needs to be altered. If there are many objects that the SSAC wishes to alter, being able to first read the current positions/values of objects in the CSAC before transferring data means the SSAC can be made to remove data that it can determine doesn't need to be altered before sending data over, reducing the workload of the CSAC, which is preferable since the CSAC response time is important in the overall decision-making process and shouldn't be burdened with tasks not relative to the immediate interaction about which a decision is being made, while the subconscious part of the system can perform functions in its own time. In some embodiments, a two-way connection may be used with the inclusion of a conditional statement that chooses a method based on the number of object data that the SSAC wishes to alter. For example:

| | |
|---|---|
| O = Object Count | M = Minimum Count |

if (O >= M) {

//check objects
//send data

} else {

//send data

}

When data reaches the CSAC, it needs to be read so that the stored object data can be updated accordingly. There are different ways it can be handled, including but not limited to:
Absolutely—When data is absolutely handled, object positions and values are simply replaced. If object data sent from the SSAC says that the object, within the CSAC, should have the position/value changed from E to Y, they are changed from E to Y.
Progressively—When data is progressively handled, object positions and values move towards a desired position/value by X degree. For example, if object data sent from the SSAC says that the object, within the CSAC, should have the position/value changed from E to Y:
   It may only reach O, which is half way, and the SSAC may need to repeatedly send data with the position/value of Y before the object position/value actually becomes Y in the CSAC.
   It may move closer to Y over a given period, such as at a rate of one position/value a day.
Only two rules must be followed with the progressive system:
   An object's old position/value must not be changed to the position/value specified by the SSAC in a single instance.
   An object's old position/value must be able to reach the new position/value, or as close as possible without going past the designated position/value, over time if there is no interference.
Two things to note:
   Obvious exceptions to the first rule are:
      if no value or position exists between the old and new; and
      if, based on the mechanics used, the new position/value given by the SSAC would have been the first new value/position moved to.
   The reason “no interference” is stated in the second rule is that, in a progressive system, it is entirely possible for the SSAC to issue a second new position/value before the object in the CSAC reaches the final new position/value that was given.
Where the object positions/values become in the CSAC each step of the way until reaching the final new position/value, as given by the SSAC, depends entirely on the mechanics implemented. Examples of mechanics that can be used are described in patent GB1517146.5, where principles of mathematics and formal logic are used to adjust the positions and values of objects within the scales and charts. As also mentioned in said patent, any mechanic can be used as long as it allows for an object to traverse charts and/or scales by position/value in at least two directions. To complete the progressive system, a rule must be added to the mechanic to define the rate of movement. This, too, can be done multiple ways. For example:
   An object's position/value changes X degree every Y days.
   The difference in degree of an object's old and new positions/values is calculated and the objects position/value changes by X degree every X hours, where the degree is a percentage, factor or nearest integer of either of the difference in degree.
In some embodiments, limitations may be imposed to control the changing of an object's positions/values. For example:
   An object's position/value may only change X degrees towards any new position/value before it must stop unless the SSAC sends data for the object in question again.
   While in transition to the new value/position designated by the SSAC, an object's position/value must stop at its current position/value if the next position/value, based on the degree it changes in each instance, would take it past the position/value designated by the SSAC.

In some embodiments, processes required for subconscious functions continuously run as background processes. Because subconscious functions need to run without being manually executed by the AI and, for the most part at least, run at all times, the processes they use must always be ready and available. Processes solely for some (or all) conscious functions, however, can but need not run at all times as these functions are called when needed, though having them run prior to them being needed obviously reduces reaction time, which is always a bonus from a technical perspective—not always from a behavioural one.

In some embodiments, the AI is able to have multiple thoughts at once—that is, process multiple streams of data along a single type of thought path. This can be achieved in multiple ways, including but not limited to:
Using multiple data paths for each data path type; and
Using hardware techniques that allow data to be processed simultaneously, such as multithreading, multi-core processing and multiprocessing.

by, for example:
Assigning one or more threads/cores/processors to a data path; and
Allowing available threads/cores/processors to take on the tasks of other data paths when possible.

In some embodiments, an AI is able to establish a “train of thought”. By observing its own communication, a circuit is created using data paths within the AI itself that allows ideas—formed from a collection of objects—to be processed again. Repeatedly processing these ideas allows the AI to continuously develop them by, for example, taking a formed idea, evaluating the collection of objects, comparing them with previous memories—including previous ideas from the current train of thought—and making a decision about the newly formed/modified/refined idea. Observation of one's own communications may be done internally as well as externally—that is to say, the AI may observe both expressed and unexpressed ideas. Internalized (unexpressed) ideas only need to be written for the AI to observe them. This can be in raw code, as a database entry, as a file etc. In some embodiments, trains of thought can be created/continued by observing the ideas of other entities.

In some embodiments, as the train of thought progresses, the AI records memories of formed ideas. By doing so, it is able to ensure the ideas formed continue to progress in value. A basic example of how it works is:

| | | Total | |
|---|---|---|---|
| # | Idea | Value | Progressive |
| 1 | Object 1 + Object 2 + Object 3 | 18 | N/A |
| 2 | Object 1 + Object 2 + Object 3 + Object 4 | 25 | Yes |
| 3 | Object 1 + Object 2 + Object 3 + Object 4 + | 28 | Yes |
| | Object 5 | | |
| 4 | Object 1 + Object 2 + Object 3 + Object 4 + | 20 | No |
| | Object 5 + Object 6 | | |
| 5 | Object 1 + Object 2 + Object 3 + Object 4 + | 35 | Yes |
| | Object 5 + Object 7 | | |
| 6 | Object 1 + Object 2 + Object 3 + Object 4 + | 40 | Yes |
| | Object 5 + Object 7 + Object 8 | | |
| 7 | Object 1 + Object 2 + Object 3 + Object 4 + | 38 | No |
| | Object 5 + Object 7 + Object 8 + Object 9 | | |
| 8 | Object 1 + Object 2 + Object 3 + Object 4 + | 43 | Yes |
| | Object 5 + Object 7 + Object 8 + Object 10 | | |

After idea number 1 has been valued, it can begin to be reprocessed. With each successive cycle, one or more additional objects are added and the idea is valued based on the objects it contains—a mechanic explained in patent GB1517146.5—and it is declared progressive or not, based upon the current value compared to the previous. When an idea is deemed progressive, the AI may continue to attempt to further an idea. When an idea is deemed not progressive, the AI may remove the object that caused the reduction and try a different one. This may continue until progression is made.

When the AI chooses to stop the train of thought and use the latest progressive idea can occur at different times and based on different rules, such as but not limited to:
When it creates the first non-progressive idea;
After X amount of successive ideas deemed non-progressive;
When the value of an idea is X amount higher than a minimum value;
After X amount of total ideas.

The value of ‘X’ can be manually set by a human or AI, made a random number or automatically determined based on an algorithm used to find the number of ideas required for adequacy when determining efficiency, convenience, probability etc.

In some embodiments, an AI may record an idea in its memory for use beyond the immediate train of thought—primarily for future reference in comparisons and decision-making. The information within the memory will need to contain, at the very least, the objects of the idea. The information may also contain the value of the idea. The memories can then be used by the AI at a later point in time by searching through the list for the same or similar ideas to one it is having in the moment and comparing values (or any other properties it may have stored) to (help) determine whether or not it is an idea that may be worth pursuing. For example, if the idea previously wasn't worth pursuing with a value of 40 but, since then, the AI has changed how it values the objects of the idea, giving the idea a new value of 85, it would deem it worth pursuing if the threshold for pursuit was, say, 60.

In some embodiments, an AI may “forget what it was thinking” or “lose its train of thought” altogether. This isn't necessarily a ‘feature’ that can be coded but actually something that is declared in response to an event that causes function and/or data deficiency, such as:
Any general computer error that causes the operation to be interrupted;
Data traffic increasing beyond the point of the AI being able to process it efficiently;
Hardware failure which sees the AI physically unable to function adequately; and
If the AI is powered down or suffers some sort of power failure.

In some embodiments, the AI is able to regain its train of thought. To do so, the AI would have needed to store current ideas of a train. When functionality has been restored, the AI simply refers back to the memory of ideas of the thought it wishes to regain and continues processing.

In some embodiments, an AI is able to have intuitive abilities. Two types of intuitive abilities are possible:
Physical—Physical intuition requires detection devices for observation, such as radars, sonars and sensors (as shown by figure point 501), that are able to detect physical properties that can't otherwise be detected by the five traditionally recognised methods of perception in a given situation. To qualify as intuitive abilities, the detection devices can be permanently, periodically, randomly or manually activated but the use of whatever ability a device provides must be passive, otherwise it simply becomes an active ability within the AI's control. Examples of such abilities and their use in situations are:
   Presence Detection: When an AI is facing in direction X and an object is out of sight in direction Y, the use of a radar can tell the AI where the object is located without the AI having to actively use its sense of sight.
   Temperature Detection: When the AI is interacting with a person, thermal sensors may detect that said person has a higher than usual body temperature, indicating that the person may be pregnant or ill. When the AI is interacting with another AI, thermal sensors may detect an above recommended operating temperature in the other AI, indicating that the AI may be overworking or infected with malware.
   Weather Detection: Barometers of an AI may detect changes in atmospheric pressure, indicating the weather may be about to change.
Mental—Mental intuition doesn't require any additional hardware. It is as best an educated guess that can be deduced based on information relating to the subject. When data is observed, the AI requires use of an algorithm which sees its memory searched for data that is of closest relation to as many objects as possible within the observed data. In the event that the algorithm results in multiple options, the AI can be made to use one or more methods to select one option, including but not limited to:
   Selecting an option of the highest value, based on the total value; and
   Random selection.

Data gathered using intuitive abilities are restricted to subconscious data paths, due to the fact that the AI is not allowed to consciously decide what the detected information means. In embodiments that primarily use a single data path, the data must travel along the path, when possible, that avoids conscious decision-making logic.

Though it is accepted that intuition cannot use reason or logic, an exception can be found when implementing the ability in AI: one cannot be said to use reason or logic unless it is a conscious decision to do so; as intuited data travels via a subconscious data path, the AI cannot make the decision to use any type of reason or logic—it is automatic and out of the AI's control—and it cannot be declared that the AI is using logic or reason to arrive at a conclusion based on intuited data—whether right or wrong—if the AI has not chosen to do so and is therefore not actually aware of it.

In some embodiments, the PARS, in combination with memory data, objects and/or a method of observation, can be used to set specific intuited responses. These can be manually implemented by human or AI, or automatically implemented by observing different responses in general to intuited events over time, recording outcomes and determining the most desired outcome based on the event that follows, efficiency, convenience, performance etc. The response that corresponds to the most desired outcome is then selected and implemented. When dealing with this automated aspect of the intuition function in particular, this is the only point where conscious observation can come into play as the learning process may begin with the active observation of the outcome event. However, it is also possible to conduct the learning process using subconscious observation. The mechanics to be used can be similar to those described on pages 25-26 in patent GB1517146.5, where the AI tests for desired results based on actions and outcomes.

In some embodiments, an AI is able to have instinctive abilities and feelings. To do so requires:
Abilities and/or objects to be pre-programmed; and/or
Functions provided by an invention, such as the one described in patent GB1520019.9, which sees an AI genome able to reproduce/replicate and pass on functions and/or abilities and/or objects with their values.

In the first instance, pre-programmed instinctive abilities and feelings are easy to implement:
The code for each ability is stored in action memory and the conditions for each ability to activate and deactivate are set.
Objects are positioned and given values within the SAC and the productivity and reactions set in the PARS.

The second instance must combine the workings of the DTCS with the workings of the genome for the automatic implementation of instinctive abilities:
The AIGC of the AIG reads the location of what is to be inherited from within the AIGO.
The AIGC moves/copies the data from the AIG into the correct places within the DTCS. For example:
   Implementing the abilities into the action memory.
      Along with any ability are the conditions for said ability to activate and deactivate.
   Implementing objects into the correct positions and with correct values.
      If possible, productivity and reaction settings are set in the PARS.

As implied, the effects of instinctive abilities and feelings activate automatically. This happens in (at least) two stages:
Stage 1—The Cause: An object and/or event are observed—this can be either consciously or subconsciously. The objects of the event are run through the SAC to determine positions and values.
Stage 2—The Feeling: The objects cause an automatic change to how the AI feels. For example, if the object ‘wolf’ was positioned under ‘fear’ and had a value of 7 on a scale with a maximum of 10, the AI could be left feeling scared.
Stage 3—The Action: The data is now passed to the PARS, where data may be exchanged with a memory unit, should it need to be, to determine or explain a reaction.
   A reaction to an event can go directly from the PARS to “other logical functions” and on to communication, with no explanation for the reaction necessary. Using the example from Stage 2, this could be the act of running away from the object of fear—the wolf—though the AI may never have encountered one before.
   Data from the PARS may travel to “other logical functions” via a memory unit and subconscious data path 502. This allows the reaction data to include a reason for the reason based on a memory without needing to return to the PARS (which can be done, if designed that way). This reason can be both communicated and observed by the AI internally. Using the wolf example, the AI may be made aware that the reason for the reaction is based upon the memory of it reading about how vicious wolves can be.

In some embodiments and/or in some situations, only one out of stages 2 and 3 occur.

Over time, instinctive feelings and reactions may change based on experiences. As object values and positions change and memories are created based on specific events, the value of events will change and, in turn, so will the data the PARS determines.

In some embodiments, instinctive reactions may be superseded/suppressed by the current and/or resulting state of the AI.
Current state: Using the ‘margin of change’ mechanic explained in patent GB1517146.5, it becomes possible for an AI to be too much of X to become or be affected by Y.
Resulting state: Once the objects of an event have taken effect and caused a modification in feeling (should that be the effect they have), the resulting action of the resulting feeling may be the action the AI goes with. For example, if the AI is currently at a fear level of 3 and the encounter with the wolf raises fear level to 10, though the instinctive reaction to the wolf may be to run, the reaction of fear level 10 may be petrification, causing the AI to stand still.

One way to ensure the correct instinctive action is made in an event is to use a mechanic similar to the priority mechanic described in patent GB1517146.5. Using such a mechanic, prioritize the instinctive reaction based on the current event higher than the reaction based on the AI's state and decisions.

In some embodiments, an AI is able to internally process streams of data used for the basis of mental imagery. To achieve this, a component needs to be connected to a memory unit in which visual object information is stored. This is shown in FIG. 5.2 as the ‘vision centre’. With visual object data, an AI is able to compose mental imagery simply by calling object data into play. Inside the AI, mental imagery is nothing more than specific descriptive texts. The imagery can only then be viewed in picture form using a visual medium, such as a screen, or special techniques that allow the AI to physically recreate their thoughts, such as robot arms that allow the AI to draw what it is imagining. There are multiple ways in which mental imagery can be composed, including but not limited to:
Random Imagery—The simplest way, requiring the AI to pull random visual image data for objects which are positioned where the AI sees fit.
Coherent Imagery—Mental images that use coherent imagery require an object relationship system, such as ConceptNet, that allows the AI to understand how objects relate to each other. The AI can then use this information to select and position objects based on how they relate.

For the AI to create mental imagery, an object database with specific reference IDs is required. A basic example of how this may look is as follows:

| Reference | Object | Image |
|---|---|---|
| sky | Sky | sky.ext |
| sun | Sun | sun.ext |
| cloud | Cloud | cloud.ext |
| soil | Soil | soil.ext |
| tree | Tree | tree.ext |
| leaves | Leaves | leaves.ext |
| grass | Grass | grass.ext |
| flowers | Flowers | flowers.ext |

This can be extended to work in conjunction with an integrated object relationship system, looking something like the following, for example:

| Reference | Object | Image | Relationship | In Relation To |
|---|---|---|---|---|
| sky | Sky | sky.ext | Above | ‘soil’ |
| sun | Sun | sun.ext | Appears in | ‘sky’ |
| cloud | Cloud | cloud.ext | Appears in | ‘sky’ |
| soil | Soil | soil.ext | below | ‘sky’ |
| tree | Tree | tree.ext | Grows from | ‘soil’ |
| leaves | Leaves | leaves.ext | Grows on | ‘tree’ |
| grass | Grass | grass.ext | Grows from | ‘soil’ |
| flowers | Flowers | flowers.ext | Grows from | ‘soil’ |

This system can be extended even further to include properties. Property field values define how the AI is able to imagine an object. For example:

| | | | | In | |
|---|---|---|---|---|---|
| | | | | Relation | |
| Reference | Object | Image | Relationship | To | Colour |
| sky | Sky | sky.ext | Above | ‘soil’ | Various ▾ |
| sun | Sun | sun.ext | Appears in | ‘sky’ | Yellow |
| cloud | Cloud | cloud.ext | Appears in | ‘sky’ | Various ▾ |
| soil | Soil | soil.ext | below | ‘sky’ | Brown |
| tree | Tree | tree.ext | Grows from | ‘soil’ | Brown |
| leaves | Leaves | leaves.ext | Grows on | ‘tree’ | Various ▾ |
| grass | Grass | grass.ext | Grows from | ‘soil’ | Green |
| flowers | Flowers | flowers.ext | Grows from | ‘soil’ | Any [symbol] |
| | | | | | Multiple ▴ |

The above take includes a property column called ‘Colour’. Within this column are 3 different types of fields:
Single Value—Identifiable by the single colour name, such as ‘Brown’ in the ‘Soil’ row, with no symbol indicator next to the name. Single value fields only have one value for the AI to use.
Various Values—Indicated by downward facing triangles (▾). These fields allow the AI a single choice from a selection of values. The selection available is dependent upon the object in question. For example, the selection list of colours available for the ‘Sky’ object may be something like this:

Colour selection for: Sky

| | | | |
|---|---|---|---|
| Blue | Navy | Orange | Red |

Multiple Values—Indicated by upward facing triangles (▴). Multiple value fields are like Various Values fields but allow the AI to make multiple choices.
Any Value—Indicated by right facing triangles ( [symbol] ). This selection isn't specific to the object in question but contains all possible values for any property that the AI holds. For example, the complete colour selection may look like this:

Colour Selection

| | | | | | |
|---|---|---|---|---|---|
| Blue | Yellow | Orange | Red | Navy | Purple |
| Pink | Green | Black | White | Gold | Grey |
| Brown | Magenta | Silver | Tan | | |

In some embodiments, only one field type is available. In some embodiments, one or more different field types than the examples listed are available. In some embodiments, the AI can be given the values for any properties by another entity. In some embodiments, the AI can add properties it can determine through one or more methods of observation. The values of fields or field types themselves do not have to reflect reality, though they may, but are simply used to give the AI as much or as little creative freedom as one wishes.

Now, for the AI to create mental imagery—whether in code or imagery—two things are absolutely required:
A way for the AI to know where to find the image file for object it wishes to use; and
A way for the AI to position the object.

Using the above, the AI is able to create rudimentary mental images in code alone, but other features can be implemented, such as classes, instances, IDs etc., to improve functionality and enhance the capabilities of the AI.

As an example of how this system can be developed to better the results, the following shows how this can be made possible:
The AI can begin by creating a solo instance of an object with an object ID so it can be referenced:
   #rose {}
The image location for the object the AI wishes to display can be referenced:

#rose {

image: rose.ext;

}

Properties can be set for the object based on the properties the AI understands the object may have:

#rose {

image: rose.ext;
colour: pink;

}

Since this is purely code, a position description can be used to help the AI or another entity understand where the object should be placed, using the information it has stored in the relationship system to determine the relationship between the object being created and other objects in use:

#rose {

image: rose.ext;
colour: pink;
pos-desc: in hand of #human1;

}

With no visual medium, such as a screen, to see for precise positioning of objects in picture form, the AI can use mathematics to determine where an object should be positioned using at least one reference point and a unit of measurement to create a grid or co-ordinate system. From the reference point, the AI can measure in units in one or more axes to position objects.

#rose {

image: rose.ext;
colour: pink;
pos-desc: in hand of #human1;
pos-x: 13;
pos-y: 8;
pos-z: 8;

}

The downside to a method such as this one is that for any type of precision to exist that is not random or luck, the AI needs to have numerous specific details about every object it contains within its memory—primarily the exact dimensions and positions of one or more individual parts of an object that it deems important. Using the example set in the position description, the AI may need to know the height, width, possibly depth and position of the hand of humanl if it is to precisely place within it the rose object.
The size of objects can also be set based on a unit of measurement.

#rose {

image: rose.ext;
colour: pink;
height: 3;
length: 1;
width: 1;
pos-desc: in hand of #human1;
pos-x: 13;
pos-y: 8;
pos-z: 8;

}

Since we can see here that the positions for three different axes have been set, we know the image and objects are going to be displayed on a three-dimensional plane.
Rather than having to duplicate code to create more than one version of an object, instances can be used that allow a single piece of code to create multiple objects.

#rose {

.instance-1 {

image: rose.ext;
colour: pink;
height: 3;
length: 1;
width: 1;
pos-desc: in hand of #human1;
pos-x: 13;
pos-y: 8;
pos-z: 8;

}
.instance-2 {

image: rose.ext;
colour: white;
height: 3;
length: 1;
width: 1;
pos-desc: growing in grass;
pos-x: 13;
pos-y: 8;
pos-z: 2;

}

}

Group instances can be used to create multiple instances of an object in one go. When using group instances, additional information may need to be included, such as quantity and spacing, as well as the area within which they need be spaced, alignment etc.

#rose {

.instance-1 {

type: single;
image: rose.ext;
colour: pink;
height: 3;
length: 1;
width: 1;
pos-desc: in hand of #human1;
pos-x: 13;
pos-y: 8;
pos-z: 8;

}
.instance-2 {

type: group;
quantity: 100;
spacing: 0.5;
image: rose.ext;
colour: white;
height: 3;
length: 1;
width: 1;
pos-desc: growing in grass;
area-point-1: 10, 10, 0;
area-point-2: 10, −10, 0;
area-point-3: −10, −10, 0;
area-point-4: −10, 10, 0;
area-type: regular;
alignment: bottom;

}

}

With the inclusion of a group instance, additional information has been included to specify where and how the AI wants the objects of the instance to be located, as well defining the shape of the area in which the objects will exist—based on the four area points (co-ordinates) and area type, we can see that the shape is to be a square, flat against a horizontal plane.
To prevent the need of lines of code, values can automatically be inherited if set in a parent and not overwritten within an instance.

#rose {

image: rose.ext;
height: 3;
length: 1;
width: 1;
.instance-1 {

type: single;
colour: pink;
pos-desc: in hand of #human1;
pos-x: 13;
pos-y: 8;
pos-z: 8;

}
.instance-2 {

type: group;
quantity: 100;
spacing: 0.5;
colour: white;
pos-desc: growing in grass;
area-point-1: 2, 2, 0;
area-point-2: 2, −2, 0;
area-point-3: −2, −2, 0;
area-point-4: −2, 2, 0;
area-type: regular;
alignment: bottom;

}

}

Code that was the same in both the single and group instances have been moved to the parent instance, automatically applying them to all child instances created. Since none have been overwritten within the code of any child instances, they all apply as stated within the parent.
‘Random’ as a value option can be used in multiple ways, such as:
   alone, simply selecting a random value from what the AI has stored when the code is executed.
   in combination with numeric options to indicate how many random values should be output.

#rose {

image: rose.ext;
height: 3;
length: 1;
width: 1;
.instance-1 {

type: single;
colour: pink;
pos-desc: in hand of #human1;
pos-x: 13;
pos-y: 8;
pos-z: 8;

}
.instance-2 {

type: group;
quantity: 100;
spacing: 0.5;
colour: random(‘all’);
pos-desc: growing in grass;
area-point-1: 2, 2, 0;
area-point-2: 2, −2, 0;
area-point-3: −2, −2, 0;
area-point-4: −2, 2, 0;
area-type: regular;
alignment: bottom;

}

}

The value “random('all')” was given to the property “colour”. The term ‘all’, referring back to visual object data, is the AI randomizing the colours of the group of roses instances based on all the colour data it has stored for the object. Other examples of possible options are “random( )” to randomly select a single value and “random(4)” to randomly select four values.
Pattern data can be used to create decorative/organized designs with objects and/or colours.

#rose {

image: rose.ext;
height: 3;
length: 1;
width: 1;
.instance-1 {

type: single;
colour: pink;
pos-desc: in hand of #human1;
pos-x: 13;
pos-y: 8;
pos-z: 8;

}
.instance-2 {

type: group;
quantity: 100;
spacing: 0.5;
colour: random(‘all’);
colour-pattern: stripes-vertical;
pos-desc: growing in grass;
area-point-1: 2, 2, 0;
area-point-2: 2, −2, 0;
area-point-3: −2, −2, 0;
area-point-4: −2, 2, 0;
area-type: regular;
alignment: bottom;

}

}

Using pattern data in combination with colour, the AI wishes to create a bed of roses in a colourful stripe pattern.
Other properties can be implemented, such as those that allow the execution of pre-written code that can used to control animations and behaviours, and for layering (especially in 2D image creation).

#rose {

image: rose.ext;
height: 3;
length: 1;
width: 1;
.instance-1 {

type: single;
colour: pink;
pos-desc: in hand of #human1;
pos-x: 13;
pos-y: 8;
pos-z: 8;

}
.instance-2 {

type: group;
quantity: 100;
spacing: 0.5;
colour: random(‘all’);
colour-pattern: stripes-vertical;
pos-desc: growing in grass;
area-point-1: 2, 2, 0;
area-point-2: 2, −2, 0;
area-point-3: −2, −2, 0;
area-point-4: −2, 2, 0;
area-type: regular;
alignment: bottom;
animation: “sway”;

}

}

The group instances of the rose objects have been given a “sway” animation, referencing a set of code that has been pre-written.
Lastly, to reduce the number of lines of code, we group relative sets of information.

#rose {

image: rose.ext;
dimensions: 1, 1, 3;
.instance-1 {

type: single;
colour: pink;
pos: ‘in hand of #human1’, 13, 8, 8;

}
.instance-2 {

type: group;
quantity: 100;
spacing: 0.5;
colour: random(‘all’), stripes-vertical;
pos-desc: growing in grass;
area: (‘2, 2, 0’, ‘2, −2, 0’, ‘−2, −2, 0’, ‘−2, 2, 0’), regular;
alignment: bottom;
animation: sway;

}

}

All values relative to properties such as area and colour have been grouped accordingly.

Though the above example is shown in a step-by-step method, the actions do not need to be performed in such an order to accomplish the task. Code and coding method/styles are also examples and can be created to be used in any way seen fit. Also, how the AI acquires values and pre-written code is irrelevant—they can be observed, constructed by the AI, written and implemented by a human or whatever other means possible. What is important and relevant is that the AI is able to compose the code necessary to create the mental imagery from objects it knows of and/or creates. An easy way to do this is to keep code simple, as shown in the examples above, using “property/value” pairs, much like in CSS. The AI simply creates the parent instance, any child instances depending on how many instances are required individually and in groups and then selects values from those available for any properties it wishes to implement. As previously stated, the positioning of objects depends on whether the imagery is to be random or coherent—to any degree for either option.

With a few more lines of code for other objects, it is possible for the AI to create the complete set of code for a mental image—a somewhat coherent one, at least, implied by the position description in the above example.

While the code may be written by the AI to control the display of objects, the objects still need a way of being displayed for visual communication and, if desired, confirmation of precision. For this, a visual canvas is required that actually displays the objects in image form. Along with the canvas must be the system to actually translate the code.
Code Translation—Though the code examples shown above are very similar in nature and style to CSS, no actual mark up code (like HTML) is required. The only 3 things the software is required to do on the coding side are:
   Pull the image file, based on the reference;
   Apply the necessary properties; and
   Position the object.
This creates self-contained code. Though this isn't a requirement, it simplifies the process significantly, making it easier to be used by the AI than having to deal with multiple coding languages and natures. This also significantly reduces the number of lines of code that must be read and executed to create imagery. The software can be set to render all code or only code that doesn't contain an indication to prevent rendering. Overall, this significantly improves the efficiency of the capability.
Canvas—The canvas(es) upon which imagery is composed only requires a 2D or 3D grid for objects to be placed.

The translation and canvas system, referred to as the Mental Imagery Display System or “MIDS”, can be located within the AI, for example, as part of the vision centre or as a communication component, or within external devices. To then display mental imagery, the AI needs to connect to a visual medium and:
If the MIDS is stored within the AI, the AI only needs to connect to the visual medium and transfer the display data.
If the MIDS is stored on the visual medium, the AI needs to transfer/stream the code to the visual medium where the MIDS translates and renders the code before display.

Mental imagery can be both a conscious and subconscious process with both conscious and subconscious results. The following is an example of how the process can work, based on the configuration of FIG. 5.2, which happens in three distinct parts.

Part 1—Data to the vision centre:

To start the process, data needs to reach the vision centre. As usual, the data path travelled depends on how the data was observed. The data may enter the vision centre at two types of points:
Pre-reaction Point: Data is sent to the vision centre before it can cause a change of state to take place in the AI.
Post-reaction Point: Data is sent to the vision centre after it can cause a change of state to take place in the AI.

Part 2—Creation:

The creation process depends on the mechanic used, five of which are described:
Face Value: Creation based on face value sees the AI prioritize object value and primarily focus on using objects of the same or similar value as each other or of at least one specific object, such as the object(s) that triggered the creation process.
State: Creation based on state sees the AI prioritise how it feels and primarily focus on using objects of the same or similar value as how it currently feels.
Face Value+State: Taking both into account, the AI has at least two options:
   Calculate a value based on the object value and state before using objects that match the equated value; or
   Use objects that match at least one value.
Target Value: Creation based on target value sees the AI primarily focus on using objects of the same or similar value as a target value it has been given. For example, if someone said to the AI, “Create a happy image for me”, “happy” would be the target and primarily “happy” objects would be used.
Neutral—Neutral creation has no specific basis. The AI freely takes any direction it so desires.

One or more of the above mechanics may be used in an AI. In embodiments that use more than one mechanic, which mechanic is to be used can either be random or conditional. Both can also be possible, where a condition, if met, enables a random choice.

For mechanics that involve the state of the AI, post-reaction data can carry along with it data relating to the state of the AI after passing through or interacting with the SAC/SCS component—something that pre-reaction data cannot do. It is possible, however, to have the state of the AI affect the creation process with pre-reaction data. To achieve this, the state of the AI, at any given time, must be stored somewhere that makes the information available to the vision centre prior to or along with the pre-reaction data. Storing the state within the vision centre and updating it whenever there is a state change is a very efficient and most reliable way of achieving this.

During creation, data travels between the vision centre and memory units to allow the vision centre to pull new objects based on the objects already in use. It is possible for a mass of data about multiple objects to be sent from a memory unit to the vision centre in one go but it may prove to be a less efficient method, depending on both hardware and software capabilities of the AI, as the flood of data may cause the vision centre or AI as a whole to encounter performance reductions. Additional conditional mechanics are also needed, in such a case, which tells the AI when to choose from the mass of data and when to request new data from a memory unit, unless it is specified that the AI is to exhaust X amount of data from the mass before requesting new data. Overall, using mass data can reduce the creative freedom of the AI and limit what is capable of creating in comparison to what can be achieved using single or manageable chunks of data at a time.

In some embodiments, if mental imagery is meant to be coherent, the way objects are selected may also be dependent upon the desired nature of some imagery. Using the object relationship system, the AI can select relationships that are in line with the overall nature (value) it is primarily using as a basis. For example, if the AI is using ‘anger’ as a basis, aside from using objects that have ‘angry’ as a value, the AI may also use objects that have angry relationships between each other, determined by examining the objects contained within said relationship's description. Object X and Object Y may both have values of ‘indifferent’ individually, but if the relationship between the two objects is ‘ X murdered Y’ and the AI values ‘murder’ as ‘angry’, it can determine that, together, these two objects have an ‘angry’ value.

The overall nature of a mental image can be calculated based on the objects and relationships between objects used in the image. Again, example mechanics for calculating a value based on numerous objects can be found in patent GB1517146.5, but other mechanics may also be used, such as the mode or mean. It is possible to declare multiple natures simply by using more than just the most prominent or dominant values.

Part 3—Data from the vision centre:

Multiple paths may be taken when data is sent from the vision centre, for multiple reasons, including but not limited to:
To Observation: The most logical option sees mental image data read by an observation component, allowing the AI to observe and react to what it created. Such paths lead to the AI being able to react to the data observed as it would if the data was observed in an external environment.
To Communication: A path to a communication component that skips most, if not all, other components, but, most importantly, the decision-making component, allows the AI to communicate its mental images without being able to choose whether or not they should be communicated. This may also be achieved using a subconscious data path to observation and then following the general subconscious data path around the AI, but this depends on what logic is stored in the ‘other logic’ component section and what it does.

In some embodiments, the vision centre may be set to activate and start processing data without being triggered by the incoming of data that is currently being processed but by automatic activation—either randomly or conditionally. To do so, the vision centre needs to request/pull data from a memory unit which acts as the first building block for the mental image. The creation process can then continue as described above.

Mental imagery techniques not only allow the AI to create mental images as part of a conscious thought process but, as subconscious processes, allow the AI to experience ‘dreams’—mental images the AI subconsciously creates that cannot be controlled. Though AI cannot physiologically sleep, a similar effect can be achieved by shutting down conscious thought paths and processes while allowing subconscious functionality to remain active, then the vision centre automatically activating. This process can be manually induced by having another entity manually activate the vision centre while conscious thought paths are shut down. Conscious though paths may also be shut down either automatically or manually.

In some embodiments, data may bypass or pass through components, without interaction or effect, as it circulates the system. In some embodiments, some of the components shown or described are combined to create multifunctional components that can handle multiple types of tasks.

In some embodiments, data at a junction may be copied in order to allow the same data to travel multiple paths simultaneously, rather than circulating data back around to then travel a different path.

It is important to understand that what makes this invention a “dual-type control system” is not the different types of parts on a perception range or the number of data paths that exist, but the ability to perform actions that an AI both does and does not mean, intend or decide to do, with and without, respectively, the ability to use any decision-making logic controlled by the AI that directly affects which action is performed. Though the mechanics that cause a result in each type can be the same or similar, the differences are significant with just as significant implications:
Type 1: Conscious—A set of options. During at least one step of the process, the AI can choose whether or not to continue and/or what action to perform and/or whether or not an action should be performed, based on the current result. This means that conscious decisions do not have to follow the path that logic dictates.
Type 2: Subconscious—A set of rules. The rules are followed from start to finish, regardless of the current result at any point, unless conditional statements are implemented as part of the rules. Results are not weighed during the process but outcomes can be after, which may or may not affect the outcome next time through experience-based learning. This, unlike type 1, follows the path logic dictates, based on what an AI knows, even if the result is not generally logical in itself.

An example of a situation to show the workings of each type is:

An AI observes gunfire while walking with a human.

| Question | Conscious | Subconscious |
|---|---|---|
| Are bullets dangerous? | Yes | |
| Could bullets kill me? | Yes | |
| Do I want to die? | No | |
| Do I want the human to die? | No | |
| Was I created to die for the human? | No | |
| Outcome: Do I save the human? | Yes | No |

Conscious and subconscious decision making need not have different results, as they do above, but it depends on the relationships and/or priorities and/or values of an AI, and/or the mechanics implemented for conscious and subconscious activity and/or how data was observed and/or how the AI questions an event. One result has the ability to change the entire outcome.

Data paths simply describe the type of data (conscious or subconscious—can be established by data tagging or other methods) travelling between components.

In some embodiments, a system such as the one described can be implemented using a more hardware-focused approach. Two examples of this are:
Circuits—ICs and PCBs, where mental components are implemented as complexes or single components, data paths are created using buses and peripheral components are connected using ports.
Multiple Computer Systems—Where each computer system operates as one or more component of the system, data paths are created using one or more forms of wired or wireless communication and peripheral components are connected using ports or wirelessly.

Though it may not be shown in the included drawings, it is an obvious fact that components which require use of memory connect to a memory unit or have memory implemented within it.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings, including new components and additional pathways between new and/or existing components. The embodiments were chosen and described in order to best explain the principles of the invention and its practical applications, to thereby enable others skilled in the art to best utilize the invention and various embodiments with various modifications as are suited to the particular use contemplated. Claims

1. A dual-type control system, comprising:
one or more methods of observation;
two or more data paths;
one or more SAC;
two or more decision-making abilities; and
one or more methods of communication;
wherein the two or more data paths carrying data from the point of observation to the point of communication allows the data to travel via one of two paths at the point of decision making, wherein:
one path leads the data through a decision-making logic process which allows an AI, during at least one stage of the process, to choose at least one of the following:
whether or not to continue; and/or
what action to perform; and/or
whether or not an action should be performed;
based on the current result; and
one path leads data through a decision-making process that follows a set of rules, without the AI able to have any input that can influence the result, regardless of the current result at any point;
where the outcome(s) of each path is based on:
the relationships and/or priorities and/or values of an AI; and/or
the mechanics implemented for conscious and subconscious activity; and/or
how data was observed.

2. The DTCS of claim 1, wherein the outcome of each path is also based on how the AI questions an event.

3. The DTCS of claim 1, wherein a full OVS² system is implemented.

4. The DTCS of claim 1, wherein a data-tagging system is implemented to tag observed data with an ID, type and/or other information, including metadata about the observation/interaction itself.

5. The data-tagging system of claim 4, wherein an interaction monitor is implemented and monitors the interactions of the AI based on tagged data.

6. The interaction monitor of claim 5, wherein the following steps are included in the process of data being used by an interaction monitor to monitor the interactions of an AI:
a start command being sent to the interaction monitor;
interaction data being sent to the interaction monitor, comprising at least an interaction ID; and
an end command being sent to the interaction monitor.

7. The steps of claim 6, including tagging data relating to an interaction with an ID relative to said interaction.

8. The steps of claim 6, including issuing a termination command.

9. The interaction monitor of claim 5, wherein the interaction monitor can create permanent or temporary memories based on interactions.

10. The DTCS of claim 1, wherein a perception range is implemented, featuring at least two different types of perception.

11. The perception range of claim 10, wherein a Main Point of Focus is implemented.

12. The perception range of claim 10, wherein the perception range is bi- or tri- axis.

13. The perception range of claim 10, wherein one or more data paths correspond with one or more parts of the perception range.

14. The DTCS of claim 1, wherein data classing is based on one or more factors.

15. The data classing of claim 14, wherein rules are set to determine whether observed data is classed as conscious or subconscious.

16. The DTCS of claim 1, wherein, over time, SSACs influence the object values of CSACs using a method which comprises the following steps:
creating a connection between the SSAC and CSAC;
transferring object data from the SSAC to the CSAC; and
changing the values of objects in the CSAC based on their SSAC values.

17. The influence of claim 16, including setting a frequency for transfer of data.

18. The influence of claim 16, including enabling a read-only connection from the CSAC to the SSAC.

19. The influence of claim 16, wherein object values within a CSAC change absolutely.

20. The influence of claim 16, wherein object values within a CSAC change progressively.

21. The DTCS of claim 1, wherein processes for subconscious functions are run as background processes.

22. The DTCS of claim 1, wherein processes for one or more conscious functions are run as background processes.

23. The DTCS of claim 1, wherein multiple data paths exist for a single type of data path.

24. The multiple data paths of claim 23, wherein multiple streams of data of a single type of thought path are processed simultaneously, using techniques such as multithreading, multi-core processing and multiprocessing to handle streams individually.

25. The techniques of claim 24, wherein the method for processing multiple streams of data for a single type of thought path comprises assigning one or more threads/cores/processors to a data path.

26. The techniques of claim 24, wherein available threads/cores/processors take on the tasks of other data paths when possible.

27. The DTCS of claim 1, wherein a collection of objects are used to form an idea.

28. The idea of claim 27, wherein the idea is given a value based on the values of the objects it contains.

29. The idea of claim 27, wherein an idea is stored in the memory of the AI.

30. The idea storage of claim 29, wherein the value of the idea is also stored.

31. The value storage of claim 30, wherein stored ideas can be compared to current ideas to determine if an idea is now worth pursuing, based on the past and present values.

32. The idea of claim 27, wherein a method for creating a ‘train of thought’ comprises:
forming an idea;
observing an idea; and
processing said idea again.

33. The method of claim 32, wherein the method comprises comparing an idea to previous memories stored.

34. The method of claim 32, wherein the method comprises comparing the value of an idea to the values of other ideas within the train of thought.

35. The comparing of idea values of claim 34, wherein ideas are compared, based on its value, in the order in which the ideas were formed, to determine whether or not the ideas are progressing.

36. The progression determination of claim 35, wherein a non-progressive idea can have objects removed and/or replaced until it is determined that an idea is progressive over the last idea that was determined to be progressive.

37. The train of thought of claim 32, wherein the train of thought can be made to stop when one or more conditions are met.

38. The train of thought of claim 32, wherein the train of thought can be forgotten due to an event that causes function and/or data deficiency.

39. The forgotten train of thought of claim 38, wherein the train of thought can be regained by referring to the memory of the idea of the thought it wishes to regain and continuing processing.

40. The DTCS of claim 1, wherein the AI has one or more types of intuitive abilities, including but not limited to:
physical intuition, which requires detection devices for observation that are able to detect physical properties that can't otherwise be detected by the five traditionally recognised methods of perception in a given situation; and
mental intuition, which requires observation of data and the use of an algorithm that searches memory for data of closest relation to as many objects as possible within the data observed to produce one or more results;
with observed data travelling only paths that avoid conscious decision-making logic.

41. The intuitive abilities of claim 40, wherein a PARS system is used to set specific intuited responses.

42. The specific responses of claim 41, wherein specific responses are automatically implemented by observing different responses in general to intuited events over time, recording outcomes, determining the most desired outcome based on one or more of the following, including but not limited to:
the event that follows;
efficiency;
convenience; and
performance;
and selecting and implementing the response based on the most desired outcome.

43. The DTCS of claim 1, wherein an AI can have instinctive abilities and feelings using:
pre-programmed abilities and/or objects, where the code for each ability is stored in action memory and the conditions for each ability to activate and deactivate are set, and objects are positioned and given values within an SAC and the productivity and reactions set in the PARS; and/or
inherited functions and/or abilities and/or objects with their values from another AI using an AI Genome, where the AIGC reads the location of what is to be inherited from within the AIGO and then moves/copies the data from the AIG into the correct places within the DTCS.

44. The instinctive abilities and feelings of claim 43, wherein they are automatically activated by observing an object and/or event, which is run through the SAC to determine positions and values, and then one or both of the following occur:
the objects cause an automatic change to how the AI feels; and
the data is passed to the PARS, directly or indirectly, to determine and/or explain a reaction.

45. The instinctive abilities and feelings of claim 43, wherein instinctive feelings and reactions change over time as the positions and values of objects change, resulting in different determinations by the PARS.

46. The instinctive abilities and feelings of claim 43, wherein they can be superseded and/or suppressed by the current and/or resulting state of an AI.

47. The instinctive abilities and feelings of claim 46, wherein a priority mechanic is used to prioritize the instinctive reaction higher than the AI's state and decisions.

48. The DTCS of claim 1, wherein a vision centre component is able to create mental imagery by:
connecting to a memory unit in which visual object information is stored; and
calling visual object data into play, using one or more of the following methods:
randomly selecting and positioning the data; and
using an object relationship system to understand how objects relate to each other, selecting objects that relate to each other and then positioning objects based on how they relate to each other.

49. The vision centre of claim 48, wherein the AI can write lines of code that correspond with its object and positioning choices.

50. The code of claim 49, wherein properties and theirs values can be applied to selected objects.

51. The properties and values of claim 50, wherein ‘random’ can be used as a value, which sees the AI select one or more random values from the list of options it has stored for the given property.

52. The code of claim 49, wherein single and group instances can be created for an object.

53. The code of claim 49, wherein a MIDS system can translate the mental imagery code into actual images using a method which comprises the following steps:
creating a grid canvas;
pulling an image file;
applying the necessary properties; and
positioning objects on the canvas.

54. The MIDS system of claim 53, wherein the MIDS can connect to a visual medium and display the image.

55. The vision centre of claim 48, wherein mathematics can be used to determine where an object should be positioned using at least one reference point and a unit of measurement to create a grid or co-ordinate system.

56. The vision centre of claim 48, wherein data is sent to the vision centre before it can cause a change of state to take place in the AI.

57. The vision centre of claim 48, wherein data is sent to the vision centre after it can cause a change of state to take place in the AI.

58. The vision centre of claim 48, wherein the creation process is based on the values of objects.

59. The vision centre of claim 48, wherein the creation process is based on the state of the AI.

60. The creation process of claims 58 and 59, wherein it is based on both the state of the AI and the values of objects.

61. The vision centre of claim 48, wherein the creation process is based on an object target value.

62. The vision centre of claim 48, wherein the nature of the relationship between objects can be determined by examining the objects contained within the relationship's description.

63. The vision centre of claim 48, wherein the creation process is based on the relationship between objects.

64. The vision centre of claim 48, wherein the overall nature(s) of a mental image can be calculated based on the objects and their relationships with each other.

65. The vision centre of claim 48, wherein data is sent from the vision centre to an observation component, allowing the AI to observe and react to its mental imagery.

66. The vision centre of claim 48, wherein data is sent from the vision centre to a communication component via a subconscious data path, preventing the AI from being able to choose whether or not mental imagery should be communicated.

67. The vision centre of claim 48, wherein the vision centre can randomly or conditionally automatically activate, without being triggered by incoming data that is currently being processed, by requesting/pulling data from a memory unit.

68. The vision centre of claim 48, wherein an AI is able to dream by shutting down conscious thought paths and processes while leaving subconscious functionality active and then activating the vision centre.

69. The DTCS of claim 1, wherein the DTCS is implemented on an IC or PCB, with mental components implemented as complexes or single components, data paths are created using buses and peripheral components are connected using ports.

70. The DTCS of claim 1, wherein the DTCS is implemented across multiple computer systems, with each computer system operating as one or more component of the system, data paths are created using one or more forms of wired or wireless communication and peripheral components are connected using ports or wirelessly.

71. The DTCS of claim 1, wherein hardware is used that enables an AI to create data, based on how an object is perceived, for the purpose of conscious and subconscious data processing and interaction.

72. The hardware use of claim 71, wherein the following steps are included in the process of classing data as conscious or subconscious ,depending on how it has been observed:
creating a perception range with at least two different types of perception;
setting which type(s) of data each section is able to perceive; and
setting rules that determine whether data is classed as conscious or subconscious.

73. The classing of data of claim 72, wherein a perception range is able to register all data as conscious data, with the method of doing so comprising:
overlapping multiple sections of multiple perception scales of multiple components in a way that doesn't allow a section that only registers subconscious data input from existing; and/or
creating a single CoF that is as wide as the entire perception scale.
